(19) United States
(12) Patent Application Publication
(10) Pub. No.: US 2014/0037786 A1
(43) Pub. Date: Feb. 6, 2014

(54) FERMENTATION OF PROTEIN-RICH FEED

(71) Applicant: Jens Hoffner Legarth, Baekke (DK)

(72) Inventor: Jens Hoffner Legarth, Baekke (DK)

(73) Assignee: FERMENTATIONEXPERTS A/S, Bække (DK)

(21) Appl. No.: 14/006,385

(22) PCT Filed: Mar. 22, 2012
(86) PCT No.: PCT/EP12/55130

§ 371 Date: Oct. 16, 2013

(30) Foreign Application Priority Data
Mar. 22, 2011 (DK) PA201170132

(51) Int. Cl. A23K 1/00

(52) U.S. Cl. CPC A23K 1/009
USPC 426/2; 426/53; 426/635

(57) ABSTRACT

The present invention provides an improved method of preparing a fermented proteinaceous livestock feed having improved nutritional value such as increased bioavailability of protein. The invention further provides fermented proteinaceous livestock feed obtained from the method of the invention and uses thereof.

### TECHNICAL FIELD OF THE INVENTION

The present invention relates to a method of manufacturing fermented livestock feed. In particular, an improved method of manufacturing fermented proteinaceous livestock feed having improved nutritional value and on particular increased bioavailability of protein.

### BACKGROUND OF THE INVENTION

There is a continued demand in the art for high quality livestock feed having improved nutritional characteristics. The challenges are several and include reducing spoilage and the presence of potential pathogenic bacteria and organisms in the feed and improving the nutritional characteristics of the feed. Fungi are the principal cause of spoilage of livestock feed, particularly in feed comprising legumes. Some fungal species may cause serious disease in livestock consuming the feed by elaborating toxins. Bacterial spoilage may also occur although the problem is in particular in liquid feed. Animal feed may be the source of several pathogens.

For example, livestock feed is often delivered to the animals by liquid feeding systems. This causes several problems. Potential harmful bacteria and organisms are natural inhabitants of soil and vegetation and are accordingly found on feed components and everywhere in the animal's surroundings. The bacteria and other organisms present will ferment, unless prevented e.g. by sterilisation. The fermentation may result in outgrow of pathogenic bacteria or various types of yeast and moulds. This uncontrolled growth in the liquid feed may result in illness, malnutrition, diarrhoea, or even death of the animals. Furthermore, animals infected with Campylobacter spp. or Salmonella spp. may transfer the infection to humans, and therefore it is desirable to avoid such infections in animals.

Providing fermented feed such as fermented liquid feed (WO2008/006382) prepared to contain low levels of pathogenic microorganisms having a low pH (below 4.5) and high levels of lactic acid bacteria and lactic acid has been reported a valid feeding strategy to decrease pathogenic microorganisms counts along the gastrointestinal tract of growing pigs.

There is a continued demand in the art for high quality proteinaceous livestock feed and thus continued need for methods for further improving the nutritional characteristics of manufacturing processes for livestock feed, thereby improving the benefits of feed products derived therefrom to animals consuming them.

The present invention accordingly provides an improved method for high quality proteinaceous livestock feed by means of fermentation.

### SUMMARY OF THE INVENTION

An object of the present invention relates to the provision of an improved method of manufacturing fermented livestock feed.

In particular, it is an object of the present invention to provide an improved method of manufacturing fermented proteinaceous livestock feed having improved nutritional value such as increased bioavailability of protein.

The present inventor has surprisingly discovered that the application of a source phytase in the form of phytase rich plant material improves the fermentation of a proteinaceous feed. Thus, apart from increasing the bioavailability of the nutritionally important minerals bound in phytic acid complexes, the supplemented source phytase also increases the buffer capacity of the feed material to fermented and thus allowing fermentation to continue for a longer period before a low pH is achieved and the fermentation process terminates accordingly. The fermentation process provided by the present inventor thereby increases the nutritional value of the feed by increasing the overall available energy in the feed and availability of the proteins in the feed and thus increasing protein utilization.

The present inventor has also discovered that by fermentation using lactic acid producing bacteria the presence anti-nutritional factors (ANFs) in the feed may be efficiently reduced, even when applied to highly proteinaceous plant material.

Thus, one aspect of the invention relates to a method of preparing a fermented livestock feed, comprising the steps of:
(a) providing an inoculum,
(b) providing a proteinaceous feed material to be fermented, where said feed material comprises at least one proteinaceous plant material,
(c) providing a source of phytase,
   (d) combining the materials of steps (a), (b) and (c) and fermenting the product of step (b) using the inoculums of step (a).

Preferably, the fermented livestock feed is a dry feed. In another, the fermented livestock feed is a silage. The fermentation is preferably semi-anaerobic or more preferably anaerobic.

In a preferred embodiment the source of phytase is provided as plant material obtained from a crop selected from the group consisting of wheat, rye, trikale, barley, spring barley or a combination thereof. In a further preferred embodiment, said source of phytase is provided in the form of grain or bran.

Another aspect of the present invention relates to a fermented livestock feed obtained by the method of the present invention.

A further aspect of the present invention is to relates to the use of the fermented livestock feed of any of claims 25 to 28 for feeding livestock such as a monogastric animals such as pigs or poultry.

The present invention will now be described in more detail in the following.

### DETAILED DESCRIPTION OF THE INVENTION

Definitions

Prior to discussing the present invention in further details, the following terms and conventions will first be defined:

Inoculums

Inoculation refers the placement of a microorganism(s) (e.g. lactic acid producing bacteria) that will grow when implanted microorganisms a culture medium such as a fermentation tank comprising media to be fermented. Inoculum refers to the material used in an inoculation, for example a composition comprising a living organism(s), which is employed to prime a process of interest. For example, an inoculum where the bacteria are essentially lactic acid producing bacteria may be used to direct a lactic acid formation process in a culture medium in a fermentation tank comprising said media (e.g. a feed product). Thus, to “to inoculate” refers to the transfer of the inoculum to the media to be processed, for example the transfer of the inoculums to a proteinaceous feed material to be fermented in combination with a source of phytase. The primary inoculum refers to the generation of the initial inoculum in a series of repeated similar of essentially identical inoculation process, for example one or more repetitions of a fermentation process. An aliquot of the product of the formation process may be used to inoculate a new process of fermentation. Thus, the inoculation may be a fermented feed product which comprises viable lactic acid producing bacteria in sufficient amount to prime a lactic acid fermentation process of a another feed product to be fermented. The inoculum may be a in a liquid form, dry form, or essentially dry form. The moisture % of the inoculom may be adjusted in order to optimize the fermentation process. Thus, the inoculum used in the method of the present invention may be a fermented feed product. In one embodiment the inoculom is provided as essentially pure viable bacteria (such as bacteria in freeze dried form) or bacteria suspended in a suitable media prior to the application (such as a water, buffer or a growth media).

The proportion of the inoculums added to the feed product comprising said protein supplement may vary. In case it is considered that the load of undesirable microbes are significant in the feed product or the fermentation system, the proportion of the inoculum in the fermentation mixture (inolucum+feed product comprising protein supplement+additional water) may be increased to insure that the fermentation is directed by the microbes (e.g. lactic acid bacteria) of the inoculums.

Accordingly, in one embodiment of the invention, the proportion of said inoculum in the combined materials provided in step (d), is in the range of 0.1 to 99.9 vol-%, 1 to 99 vol-%, 5 to 70 vol-%, 10 to 50 vol-%, or 25 to 35 vol-%, 0.1-10 vol-%, or 0.5-5 vol-%, or 1-2.5 vol-%, or around 1-2 vol-vol-%.

It is most preferred that the fermentation process is a lactic acid fermentation. It is also preferred that the fermentation is performed under anaerobic conditions (or at least semi-anaerobic conditions).

Thus, in a preferred embodiment of the invention, the inoculum of step (a) comprises lactic acid-producing bacteria. In another preferred embodiment, the bacteria present in the inoculum of step (a) are essentially lactic acid-producing bacteria. It follows that in order to efficiently function as inoculum for directing the desired fermentation process (e.g. lactic acid fermentation), the microorganisms (e.g. lactic acid producing bacteria) should be present in a number sufficiently to outnumber any other microbes present in the inoculums and the mixture of inoculum and feed to be fermented. Thus, in one embodiment, the concentration of lactic acid-producing bacteria in the inoculum of step (a) are sufficient to outgrow any bacteria, yeast or moulds present in the product of step (b) or at least significantly inhibit further proliferation of said bacteria, yeast or moulds in the feed.

The lactic acid bacteria comprise a clade of Gram positive, low-GC, acid tolerant, non-sporulating, non-respiring rod or cocci that are associated by their common metabolic and physiological characteristics. These bacteria, usually found in decomposing plants and lactic products produce lactic acid as the major metabolic endproduct of carbohydrate fermentation. This trait has historically linked lactic acid bacteria with food fermentations as acidification inhibits the growth of spoilage agents. Proteinaceous bacteriocins are produced by several lactic acid bacteria strains and provide an additional hurdle for spoilage and pathogenic microorganisms. Furthermore, lactic acid and other metabolic products contribute to the organoleptic and textural profile of a food item. The industrial importance of the lactic acid bacteria is further evidenced by their generally regarded as safe (GRAS) status, due to their ubiquitous appearance in food and their contribution to the healthy microflora of human mucosal surfaces.

In the present invention, the lactic acid-producing bacteria in inoculom used for fermentation are mainly and non-exclusively lactic acid bacteria of the genus Enterococcus, Lactobacillus, Pediococcus or Lactococcus, or combinations thereof. In one embodiment of the present invention the inoculum comprises at least one lactic acid bacterium species selected from the group consisting of one or more of Enterococcus spp., Lactobacillus spp., Lactococcus spp., and Pediococcus spp. In yet a further embodiment of the invention, the lactic acid bacteria are selected from the group consisting of one or more of Enterococcus faecium, Lactobacillus rhamnosus, Lactobacillus plantarum, Pediococcus acidililactili, and Pediococcus pentosaceus. In further embodiment, the lactic acid producing bacteria are of the order Lactobacillales. The lactic acid-producing bacteria can also be selected from Lactobacillus spp., Pediococcus spp., Enterococcus spp., and Lactococcus spp. or a combination thereof. In yet another embodiment, the lactic acid-producing bacteria comprise Pediococcus pentosaceus, Pendiococcus acidilactici and Lactobacillus plantarum, Lactobacillus rhamnosus, and Enterococcus fæcium, or a combination thereof. In still another embodiment, the lactic acid bacteria comprise Enterococcus faecium and/or Lactobacillus rhamnosus. In a further embodiment, the lactic acid bacteria comprise one or more of Enterococcus faecium MCIMB 30122, Lactobacillus rhamnosus NCIMB 30121, Pediococcus pentosaceus HTS (LMG P-22549), Pendiococcus acidilactici NCIMB 30086 and/or Lactobacillus plantarum LSI (NCIMB 30083).

In a further embodiment of the invention, the inoculum of step (a) has been obtained by fermentation with primary inoculum comprising at least one lactic acid bacterium species selected from the group consisting of one or more of Enterococcus spp., Lactobacillus spp., Lactococcus spp., and Pediococcus spp.

Lactic Acid Fermentation

Lactic acid fermentation is the simplest type of fermentation. Essentially, it is a redox reaction. In anaerobic conditions, the cell's primary mechanism of ATP production is glycolysis. Glycolysis reduces—transfers electrons to—NAD+, forming NADH. However, there is only a limited supply of NAD+ available in a cell. For glycolysis to continue, NADH must be oxidized—have electrons taken away—to regenerate the NAD+. This is usually done through an electron transport chain in a process called oxidative phosphorylation; however, this mechanism is not available without oxygen.

Instead, the NADH donates its extra electrons to the pyruvate molecules formed during glycolysis. Since the NADH has lost electrons, NAD+ regenerates and is again available for glycolysis. Lactic acid, for which this process is named, is formed by the reduction of pyruvate.

In heterolactic acid fermentation, one molecule of pyruvate is converted to lactate; the other is converted to ethanol and carbon dioxide. In homolactic acid fermentation, both molecules of pyruvate are converted to lactate. Homolactic acid fermentation is unique because it is one of the only respiration processes to not produce a gas as a byproduct.

Homolactic fermentation breaks down the pyruvate into lactate. It occurs in the muscles of animals when they need energy faster than the blood can supply oxygen. It also occurs in some kinds of bacteria (such as lactobacilli) and some fungi. It is this type of bacteria that converts lactose into lactic acid in yogurt, giving it its sour taste. These lactic acid bacteria can be classed as homofermentative, where the end product is mostly lactate, or heterofermentative, where some lactate is further metabolized and results in carbon dioxide, acetate or other metabolic products.

The process of lactic acid fermentation using glucose is summarized below. In homolactic fermentation, one molecule of glucose is converted to two molecules of lactic acid:

C6H12O6→2 CH3CHOHCOOH.

In heterolactic fermentation, the reaction proceeds as follows, with one molecule of glucose being converted to one molecule of lactic acid, one molecule of ethanol, and one molecule of carbon dioxide:

C6H12O6→CH3CHOHCOOH+C2H5OH+CO2

Before lactic acid fermentation can occur, the molecule of glucose must be split into two molecules of pyruvate. This process is called glycolysis.

It is preferred that the fermented livestock feed of the present invention is obtained by lactic acid fermentation. It is also preferred that the fermentation is homolactic fermentation directed by homofermentative lactic acid bacteria. In one embodiment, the fermentation is heterolactic fermentation.

Phytase

Phytase (myo-inositol hexakisphosphate phosphohydrolase) is a type of phosphatase enzyme that catalyzes the hydrolysis of phytic acid (myo-inositol hexakisphosphate), an undigestable, organic form of phosphorus present in for example grains. A useable form of inorganic phosphorus is released by the hydrolysis of phytic acid.

In most commercial agriculture, non-ruminant livestock such as swine, fowl, and fish are fed mainly grains such as maize, and legumes such as soybeans. Because phytate from these grains and beans is unavailable for absorption, the unabsorbed phytate passes through the gastrointestinal tract, elevating the amount of phosphorus in the manure. Excess phosphorus excretion can lead to environmental problems such as eutrophication.

The bioavailability of phytate phosphorus can be increased by supplementation of the diet with the enzyme phytase. Also, viable low-phytic acid mutant lines have been developed in several crop species in which the seeds have drastically reduced levels of phytic acid and concomitant increases in inorganic phosphorus.

Leguminous Crop

A legume is a plant in the family Fabaceae (or Leguminosae), or a fruit of these specific plants. A legume fruit is a simple dry fruit that develops from a simple carpel and usually dehisces (opens along a seam) on two sides. A common name for this type of fruit is a pod. Well-known legumes include alfalfa, clover, peas, beans, lentils, lupins, mesquite, carob, soy, and peanuts. Locust trees (Gleditsia or Robinia), wisteria, and the Kentucky Coffeetree (Gymnocladus dioicus) are all legumes.

A pulse is an annual leguminous crop yielding from one to twelve seeds of variable size, shape, and color within a pod. Pulses are used for food and animal feed. The term “pulse”, as used by the Food and Agricultural Organization (FAO), is reserved for crops harvested solely for the dry seed. This excludes green beans and green peas, which are considered vegetable crops. Also excluded are crops that are mainly grown for oil extraction (oilseeds like soybeans and peanuts), and crops which are used exclusively for sowing (clovers, alfalfa). However, in common use these distinctions are not clearly made, and many of the varieties so classified and given below are also used as vegetables, with their beans in pods while young cooked in whole cuisines and sold for the purpose; for example black eyed beans, lima beans and Toor or pigeon peas are thus eaten as fresh green beans cooked as part of a meal.

Leguminous crops such as pulses known for their their high protein and essential amino acid content and thus are important food crops.

Rape (or Rapa, Oilseed Rape, Rapa, Rappi, Rapeseed)

Rape (such as Brassica campestris and B. napus) is a member of the Brassica genus, which include cabbage, radish, kale, mustard and cauliflower. Oilseed rapes were grown in India over 3,000 yr ago, and at least 2,000 yr ago in China and Japan. Rape is believed to have originated in the Mediterranean area.

In one embodiment, the at least one proteinaceous plant material of step (b) is derived from at least one Brassica spp. such as a rape species. In the context of the present invention, rape refers to any species, sub-species, strain or hybrid of rape. Species of rape include Brassica campestris and B. napus and strains thereof and hybrid made thereof.

In the context of the present invention products/materials of rape include rapeseeds (RS), rapeseed oil (RSO), rapeseed hulls (RSH), rapeseed (press) cake (RSC), rapeseed meal (RSM), other residues of rape from the rapeseed oil production. In the context of the present invention, the product of rape (plant material of rape) serves as a protein source in feed. It follows that the various product of rape may be used in combination, such as a proteinaceous plant material comprising a combination of rapeseed (press) cake (RSC) and rapeseed meal (RSM).

In one embodiment of the present invention at least one proteinaceous plant material of step (b) comprises rape or a rape derived material. In a further embodiment, the rape derived material is selected from the group consisting of rapeseed, rapecake, rapeseed meal, and any combination of rapeseed, rapecake, rapeseed meal. In yet a further embodiment, the rape derived product comprises rapeseed hulls. In another embodiment, rapeseed hulls are essentially not present in the rape derived material. In a further embodiment, the at least one proteinaceous plant material of step (b) is essentially of rape derived material.

Further Crops

In further embodiments the at least one proteinaceous plant material is independently selected from sunflower, palm and soya. The material may for example be provided in the form of seeds, press cake, meal or other residues of industrial utilization of said plants,

Feed Material

The term “feed material” according to the invention is to be understood in its broadest sense. “Feed material” may suitably be obtained from the dairy industry, the agricultural industry, the wine industry, the alcohol industry, or beer industry, or combinations thereof. Examples of suitable “feed material” comprise one or more of mature and/or immature plants and parts thereof, such cereals, e.g. wheat, barley, rye, rice, maize (cob maize silage (CCM) or ripe), triticale, oat; vegetables (e.g. potatoes, maize, soy; whey, curd, skim milk and the like). The feed to be fermented may also consist essentially of a composition of one or more of the proteinaceous plant materials described herein. The feed material to be fermented may include animal products such as industrial animal by-products such as blood meal and bone meal. Another non-limiting example of a useful animal product is mussels.

The terms “fermented product” or “fermented feed” indicate any product or feed that has been fermented or is in the process of being fermented.

“Liquid fermented product” indicates that the fermented product has a water/moisture content of more than 20 vol-%. In the context of the present invention, it is used as inoculum for fermentation. It can also be fed to animals directly, or in combination with another fermented or non-fermented feed, composition or product.

In the present context, the terms “fermentation” and “ensiling” is used interchangeably and is intended to have the same meaning.

Fluid Product

The terms “fluid product” or “liquid product” are used interchangeably and indicate a product with a moisture content of 20 vol-% or more, in particular 25 vol-% or more.

In order to be suitable for the fermentation according to the invention, the product will commonly have a moisture content of 20 vol-% or more, in particular 25 vol-% or more. In one embodiment of the invention, a sufficient water content (i.e. a water content of 20 vol-% or more) is provided by mixing a product with an insufficient water content (i.e. a water content of below 20-vol %), with a product with a sufficient water content, in order to provide an appropriate water content of the mixture. In a further embodiment, the combination of inoculom (provided in step (a)) the proteinaceous feed material to be fermented of step (b) and the source of phytase of step (c) is supplemented with addition of water or a water-based fluid and thus provides a mixture with appropriate water content for fermentation taking place in step (d).

In one embodiment of the invention, water is added to the proteinaceous feed material to be fermented, if the moisture content is too low for efficient fermentation. Optionally, the water can be treated, and can comprise chemical compounds and chemical compositions, such as salts, minerals, vitamins, buffering substances, organic or inorganic acids and the like. In yet another embodiment, the treated water improves fermentation.

Per Cent Moisture (% Moisture, or % H2O)

Per cent Moisture refers to the proportion of water in the material (e.g. in the feed). Volumetric water content, θ (or vol-%), is defined mathematically as: θ=V_{w}/V_{T}, where V_{w} is the volume of water and V_{T}=Vₛ+Vᵥ=Vₛ+V_{w}+Vₐ is the total volume (that is material Volume+Water Volume+Void Space). Water content may also be based on its mass or weight, thus the gravimetric water content is defined as: u=m_{w}/m_{b}, where mw is the mass of water and mb (or ms for soil) is the bulk material mass. To convert gravimetric water content to volumetric water, multiply the gravimetric water content by the bulk specific gravity of the material.

It may be advantageous to reduce the proportion of water in the fermented livestock feed obtained in step (d) for some application of the livestock feed, for example if the livestock feed is for poultry.

Accordingly, in one embodiment of the invention, the method comprises a further step of reducing the liquid/water (moisture) content in the product obtained by the fermentation in step (d). The step of reducing the liquid/water (moisture) content in the product is preferably performed under conditions that ensure high viability of the lactic acids producing bacteria present in the fermented livestock feed.

In another embodiment, the liquid content in the fermented product of obtained in step (d) is reduced to 20% moisture or less, such as less than 18% moisture, such as less than 16% moisture, such as less than 14% moisture, such as less than 12% moisture, such as less than 10% moisture, such as less than 8% moisture.

Dry Matter Content

References are made to the content of the materials or other components of the livestock feed. In the context of the present invention these references are generally made to the dry matter (also known as dry weight). In one embodiment, the content refers to the mass in matter which is 88% dry.

Genetically Modified Organism (GMO)

A genetically modified organism (GMO) refers to an organism whose genetic material has been altered using genetic engineering techniques. These techniques, generally known as recombinant DNA technology, use DNA molecules from different sources, which are combined into one molecule to create a new set of genes. This DNA is then transferred into an organism, giving it modified or novel genes. Transgenic plants, a subset of GMOs, are plants which have inserted DNA that originated in a different species.

Anti Nutritional Factors (ANFs)

Substances present in the feed which adversely affect the growth of farm animals are referred to as anti-nutritional factors (or ANFs). The presence of anti-nutritional factor in animal feeding stuff may lead reduced the voluntary feed intake, lower digestibility of the feed, and/or in other way adversely affect the health and growth of the animals. The presence of endogenous anti-nutritional factors within plant feedstuffs is believed to be the largest single factor limiting their use within compounded livestock feeds at high dietary levels.

Anti-nutritional factors (ANFs) include trypsin- and chymotrysin inhibitors, lectines, tannins, glycosides such as saponins, sinapine, erucic acid, and glucosinolates and degradation products of glucosinolates (e.g isothiocyanates).

Their presence in untreated foodstuffs typically results in anorexia, poor growth and poor food conversion efficiency when used at high dietary concentrations. Thus, the content ANFs in a plant material (e.g. plant material of Brassica Rapa) set the limit on the proportional use in feed for livestock (e.g. poultry or pigs). For example, growing finishing pigs usually do not tolerate feed comprising rape derived product in exceeding 10-12 wt % of the complete feed.

The presence of glucosinolates and their metabolites in the feed reduces feed intake, growth and thyroid function in farm animals, particularly in pigs and poultry. Glucosinolate may also be referred to as goitrogens, which are substances that suppress the function of the thyroid gland by interfering with iodine uptake, which can, as a result, cause an enlargement of the thyroid, i.e., a goitre. The goitrogenic effect of glucosinolates in animals and poultry induces enlarged thyroids, reduced circulating thyroid hormones, liver, kidney, and adrenal abnormalities, and poor growth and reproductive performance.

Lee and Hill (The British Journal of Nutrition (1983), Vol. 50 (3): 661-71) compared the voluntary feed intake of growing pigs given a diet containing rapeseed meal as the only supplement. The voluntary feed intake was significantly lower than the control diets (e.g. using soya bean meal as protein source). The effects on feed intake of adding flavouring substances to the diet containing rapeseed meal also determined. The flavouring substances, molassine meal, sucrose and four commercially-available substances: pig nectar; hog nectar; sow nectar and apple, did not improve the intake of the rapeseed meal based diet significantly. The inverse relationship between the glucosinolates content and the food intake were confirmed in a later study (Lee et al. The British Journal of Nutrition (1984), Vol. 52 (1): 159-64).

The content of anti-nutritional factors (ANFs) may be reduced by thermal treatment although such treatment is not very efficient. The present inventor has discovered that by fermentation using lactic acid producing bacteria the presence anti-nutritional factors (ANFs) in the feed may be efficiently reduced, even when applied to highly proteinaceous plant material. This method of the present invention is not only more efficient in reducing the content of anti-nutritional factors (ANFs) is high protein feed material, it is also more cost efficient in view of the energy consumption needed for the thermal treatment used in the art to reduce the amount of ANFs in the feed.

Method of Fermenting Protein Enriched

An object of the present invention is to provide a fermented product by dry fermentation. The fermented feed product obtained by the method of the present invention is preferentially not a liquid feed (not pumpable). The preferred product obtained by the method of the present invention is a silage.

A further object of the present invention is to control the fermentation process in order to reduce the proliferation of pathogenic microorganisms or microorganisms that adversely affect the organoleptic properties of the fermented feed product.

The object is accomplished by inoculating the feed material to be fermented with a composition comprising high amount of lactic acid producing bacteria, preferably the inoculums described herein.

“Silage” or “ensilage” are used interchangeably and refer to a fermented plant product to be fed to animals, commonly ruminant animals like cattle and sheep. Silage is fermented and stored, a process called ensilage. Usually, fermentation occurs via the natural microbial flora present on the plant product to be fermented. Thereby, a variety of different fermentation products can occur, including acetic acid. The fermentation process can take days, weeks or month, and the resulting fermented product, the silage or ensilage can be stored for many months. Silage is most often prepared from grass crops, including maize or sorghum. Silage is often made from the entire plant, usually excluding the roots, and not just the grain. Generally, the plant is cut into pieces, often directly during harvesting. Silage can also be made from many other field crops, and sometimes a mixture is used, such as oats and peas. The silage of the present invention is made of proteinaceous crops material obtained from at least one proteinaceous plant material, preferably at least two independently selected proteinaceous plant materials and even more preferred three independently selected proteinaceous plant materials. Haylage is a term used to describe ensiled forages, made up of grass, alfalfa and alfalfa/grass mixes and the like. It is used for example to feed dairy. Instead of fermenting in a silo, baylage is another form of silage. In this case, for example the plant or parts thereof is cut and baled while still fairly wet, and often too wet to be baled and stored as hay. The dry matter can be around 60 to 70%. The bales are wrapped tightly in plastic wrappers, wherein fermentation occurs, however such compression of the material to be fermented by also be accomplished by other means. The material to be fermented may also be place in a heap or pit and covered with sheets (e.g. made of plastic) to create the anaerobic conditions for the fermentation process.

Thus, one aspect of the invention relates to a method of preparing a fermented livestock feed, comprising the steps of:
(a) providing an inoculum,
(b) providing a proteinaceous feed material to be fermented, where said feed material comprises at least one proteinaceous plant material,
(c) providing a source of phytase,
(d) combining the materials of steps (a), (b) and (c) and fermenting the product of step (b) using the inoculums of step (a).

In the preferred embodiment, the fermented livestock feed is a dry feed. In another preferred embodiment, the fermented livestock feed is silage. The fermented livestock feed is preferably not a pumpable feed such as a liquid feed.

In a preferred embodiment, the combined material in step (d) is fermented under semi-anaerobic or more preferably anaerobic conditions. Such condition may be accomplished by compressing the material (e.g. by wrapping plastic tightly around the material during fermentation).

In a preferred embodiment, said source of phytase is provided as plant material obtained from a crop selected from the group consisting of wheat, rye, trikale, barley, spring barley or a combination thereof.

In another embodiment, the source of phytase is purified phytase enzyme or a composition comprising one or more purified phytase enzymes.

A preferred embodiment concerns a method of preparing a fermented livestock feed, comprising the steps of:
(a) providing an inoculums comprising bacteria, wherein said bacteria are essentially lactic acid-producing bacteria and where the concentration of lactic acid-producing bacteria in the inoculum of step (a) are sufficient to outgrow any bacteria, yeast or moulds present in the product of step (b) and (c) or at least significantly inhibit further proliferation of said bacteria, yeast or moulds;
(b) providing a proteinaceous feed material to be fermented, where said feed material comprises at least two independently selected proteinaceous plant materials, where the protein content of said proteinaceous plant materials is at least 20% by weight, such as at least 25% by weight;
(c) providing a source of phytase in the form of plant material obtained from a crop selected from the group consisting of wheat, rye, trikale, barley, spring barley or a combination thereof;
(d) combining the materials of steps (a), (b) and (c) and fermenting the product of step (b) using the inoculums of step (a) preferably by essentially a homo-fermentative fermentation.

In another preferred embodiment concerns a method of preparing a fermented livestock feed, comprising the steps of:
(a) providing an inoculums comprising bacteria, wherein said bacteria are essentially lactic acid-producing bacteria and where the concentration of lactic acid-producing bacteria in the inoculum of step (a) are sufficient to outgrow any bacteria, yeast or moulds present in the product of step (b) and (c) or at least significantly inhibit further proliferation of said bacteria, yeast or moulds;
(b) providing a proteinaceous feed material to be fermented, where said feed material comprises at least three independently selected proteinaceous plant materials, where the protein content of said proteinaceous plant materials is at least 20% by weight, such as at least 25% by weight;
(c) providing a source of phytase in the form of plant material obtained from a crop selected from the group consisting of wheat, rye, trikale, barley, spring barley or a combination thereof;
(d) combining the materials of steps (a), (b) and (c) and fermenting the product of step (b) using the inoculums of step (a) preferably by essentially a homo-fermentative fermentation.

In a further preferred embodiment concerns a method of preparing a fermented livestock feed, comprising the steps of:
(a) providing an inoculums comprising bacteria, wherein said bacteria are essentially lactic acid-producing bacteria and where the concentration of lactic acid-producing bacteria in the inoculum of step (a) are sufficient to outgrow any bacteria, yeast or moulds present in the product of step (b) and (c) or at least significantly inhibit further proliferation of said bacteria, yeast or moulds;
(b) providing a proteinaceous feed material to be fermented, where said feed material comprises at least three independently selected proteinaceous plant materials, where the protein content of said proteinaceous plant materials is at least 20% by weight, such as at least 25% by weight;
(c) providing a source of phytase in the form of plant material obtained from a crop selected from the group consisting of wheat, rye, trikale, barley, spring barley or a combination thereof;
(d) combining the materials of steps (a), (b) and (c) and fermenting the product of step (b) using the inoculums of step (a) preferably by essentially a homo-fermentative fermentation.

The proteinaceous plant materials are selected from independent sources of proteinaceous plant materials with the purpose of optimizing the amino acids profile of the final feed.

In an even more preferred embodiment, said source of phytase is provided in the form of grain or bran. In a further preferred embodiment, said source of phytase is wheat bran.

Thus one embodiment concerns a method of preparing a fermented livestock feed, comprising the steps of:
(a) providing an inoculums comprising bacteria, wherein said bacteria are essentially lactic acid-producing bacteria and where the concentration of lactic acid-producing bacteria in the inoculum of step (a) are sufficient to outgrow any bacteria, yeast or moulds present in the product of step (b) and (c) or at least significantly inhibit further proliferation of said bacteria, yeast or moulds;
(b) providing a proteinaceous feed material to be fermented, where said feed material comprises at least two (such as three or four) independently selected proteinaceous plant materials, where the protein content of said proteinaceous plant materials is at least 20% by weight, such as at least 25% by weight;
(c) providing a source of phytase in the form wheat bran;
(d) combining the materials of steps (a), (b) and (c) and fermenting the product of step (b) using the inoculums of step (a) preferably by essentially a homo-fermentative fermentation.

The source of phytase may be applied in different forms and different amounts depending on the nature of the proteinaceous feed material to be fermented. In one embodiment, where the content of said source of phytase in the combination the products of steps (a), (b) and (c) is in the range of 10 to 40% by weight, such as in the range of 10 to 25% by weight, such in the range of 15 to 20% by weight.

Proteinaceous Plant Material

The proteinaceous plant material is added to feed for the purpose of increasing the protein content of the final feed product.

In one embodiment of the present invention the proteinaceous feed material to be fermented is a composition of one or more of the proteinaceous plant materials described herein. In a preferred embodiment, the proteinaceous feed material to be fermented is a composition of two more of the proteinaceous plant materials described herein. In another preferred embodiment, the proteinaceous feed material to be fermented is a composition of three more of the proteinaceous plant materials described herein.

Various source of proteinaceous plant material may be used as supplement to obtain a high protein livestock feed. It is preferred that the protein content of proteinaceous plant material is at least 20% by weight in order to obtain a high protein concentration in the final product.

In one embodiment of the present invention, the protein content of said proteinaceous plant material is at least 20% by weight such as at least 25% by weight. In a preferred embodiment, the protein content of said proteinaceous plant material is in the range of 20 to 30% by weight, such as in the range of 20 to 25% by weight.

Proteinaceous plant material is preferably provided as proteinaceous plant from two or more plants. By applying proteinaceous material from two or more sources the inventor has discovered that an improved amino acids profile is obtained.

Accordingly, one embodiment of the present invention relates to a method of preparing a fermented livestock feed, comprising the steps of:
(a) providing an inoculum,
(b) providing proteinaceous feed material to be fermented, where said feed material comprises at least two independently selected proteinaceous plant material.
(c) providing a source of phytase,
(d) combining the materials of steps (a), (b) and (c) and fermenting the product of step (b) using the inoculums of step (a).

In a further embodiment, said feed product of step (b) comprises at least three independently selected proteinaceous plant materials. In yet a further embodiment, said feed product of step (b) comprises at least four independently selected proteinaceous plant materials. In one embodiment, the said feed product of step (b) comprises three or four or five proteinaceous plant materials.

The proteinaceous plant material may be obtain from various sources, preferably where the protein content of proteinaceous plant material is at least 20% by weight in order to obtain a high protein concentration in the final product.

Typically at least one of the proteinaceous plant materials is obtained from a leguminous crops such as a pulse. Leguminous crops are known for their high protein content. The leguminous crops (e.g. a pulse) may be provided in the form of whole plants in other embodiments the leguminous crop(s) is provided in the form of material derived from one or more leguminous crops such as parts of the leguminous crop or by-product of the processes using leguminous crops (such as pulses).

In one embodiment, said feed material comprises at least one proteinaceous plant material selected from a leguminous crop or leguminous crop-derived material, for example two, three, four or five proteinaceous plant material selected from different leguminous crops.

A wide range of leguminous crops are suitable for the application to the method of the present invention. A limiting list of suitable leguminous crops include lupine, Vicia faba (broad bean, field bean), variant of Vicia faba, such as Vicia faba var. equina (horse been), Pisum sativum, variants of Pisum sativum, such as Pisum sativum var. Arvense (field pea), Medicago sativa (Alfalfa) or variant thereof.

In a preferred embodiment, at least one proteinaceous plant material are derived from the rape, Brassica rapa ssp. rapa, Brassica rapa. var. Sylvestris, sunflower, algae and seaweed.

In one embodiment of the present invention relates to a method of preparing a fermented livestock feed, comprising the steps of:
(a) providing an inoculum,
(b) providing proteinaceous feed material to be fermented, where said feed material comprises at least two (such as three or four) independently selected proteinaceous plant material selected from leguminous crops, where said leguminous crops are independently selected from the list consisting of lupine, Vicia faba (broad bean, field bean), variant of Vicia faba, such as Vicia faba var. equina (horse been), Pisum sativum, variants of Pisum sativum, such as Pisum sativum var. Arvense (field pea), Medicago sativa (Alfalfa) or variant thereof.
(c) providing a source of phytase,
(d) combining the materials of steps (a), (b) and (c) and fermenting the product of step (b) using the inoculums of step (a).

The feed proteinaceous plant material may be added in various amounts. The amount of proteinaceous plant material depends on the nature of the plant material, but typically content of the proteinaceous plant material the combined materials to be fermented (under step d) is at least 5%, such as at least 10%, for example at least 15% by weight on a dry matter basis.

In one embodiment, the content of the proteinaceous feed material to be fermented in the combination of the products (a), (b) and (c) is above 15% by weight dry matter (wt %), such as more than 17 wt % such as more than 20 wt %, such more than 22 wt %, such as more than 24 wt %, such as more than 26 wt % such as more than 28 wt % such as more than 30 wt %, such as more than 35 wt %, such as more than 40 wt %.

It is preferred that the fermented livestock feed is devoid of any GMO material. In that case, it follows that that none of the biomaterials used by the method originates from gene modified organisms (GMO). Accordingly, one embodiment of the present invention relates to a method of preparing a fermented livestock feed with the proviso that said fermented livestock feed is devoid of any GMO material.

In another embodiment, the proteinaceous feed material to be fermented comprises GMO material for example in the form of transgenic plant material.

Fermentation

The method of the present invention is most preferably based on fermentation using lactic acid producing bacteria. Preferably the fermentation process is homo-fermentative and driven and controlled by lactic acid producing bacteria as most predominant fermenting organism.

Thus in one embodiment of the present invention, the fermentation in step (d) is a homo-fermentative fermentation and said inoculom comprises lactic acid producing bacteria. Thus, the fermented product is obtained by essentially a homo-fermentative fermentation controlled by the lactic acid producing bacteria in said inoculom. In another embodiment, the fermented product is obtained by a hetero-fermentative fermentation.

In one embodiment, the bacteria present in the inoculum of step (a) are essentially lactic acid-producing bacteria and where the concentration of lactic acid-producing bacteria in the inoculum of step (a) are sufficient to outgrow any bacteria, yeast or moulds present in the product of step (b) and (c) or at least significantly inhibit further proliferation of said bacteria, yeast or moulds.

In another embodiment, wherein the dry matter content of the inoculom is in the range of 2 to 10% such as approximately 5% by weight.

In another embodiment, the method of the invention comprises a further step of drying the product of step (d). In a particular embodiment, the product of step (d) is dried to a water content not exceeding 16% by weight dry matter such as not exceeding 14% by weight dry matter.

The step of drying the product of step (d) is performed after completing the fermentation, where the fermentation time is 14 days or less, such as between 24 h and 7 days, preferably around 5 days. By drying the immediately after the completion of the fermentation process and no later than 14 days after the inoculation, high viability of the lactic acid producing bacteria is ensured in the final fermented livestock feed obtained by the method.

One object of the invention is to provide the fermented livestock feed in dry form with a high concentration of viable lactic acid producing bacteria. It follows that the drying process is performed under conditions that allow the recovery of the dried product without significantly reducing or severely reducing the amount of viable lactic acid producing bacteria in the recovered dry fermented livestock feed product. The advantageous effect of the viable lactic acid producing bacteria in the final feed is obtained when the viable lactic acid producing bacteria are present in high concentration in the final fermented feed. In one embodiment, the concentration of viable lactic acid producing bacteria in the fermented livestock feed is above 10⁶ such as above 10⁷ CFU per gram fermented livestock feed, such as in the 10⁸ to 10⁹ CFU per gram fermented livestock feed.

In one embodiment, the water content in the combined materials of steps (a), (b) and (c) is in the range of 27.5% to 60% by weight dry matter, such as in the range of 35 to 50% by weight, preferably in the range of 32% to 38%. In a particular embodiment, the water content in the combined materials of steps (a), (b) and (c) is supplemented with a liquid such as water to obtain water content in the range of 35 to 60% by weight during fermentation, such as in the range of 35 to 50% by weight during fermentation, more preferably in the range of 32 to 38% by weight during fermentation.

Condition of Fermentation

The fermentation in step (d) is performed at a suitable temperature for a suitable amount of time. The temperature should be so as to ensure activity of microorganism of the inoculom e.g. the lactic acid-producing bacteria, i.e. it should not be below 10° C. or above 50° C. Preferably, the temperature during the fermentation is in the range of 30 to 40° C. In one embodiment, the temperature may be about 30° C. In another embodiment, the temperature is about 35° C. The fermentation should be continued at least until the pH has reached a suitable level, i.e. 4.2 or less, e.g. 3.5 or 3.8. Thus, fermentation should be continued up to e.g. 24 hours, or 15 hour. Sometimes, fermentation in step (d) is completed within 10, 9, 8, 5, 6, 4, 3, or 2 hours or 1 hour, or in certain cases within 30 minutes. In one embodiment, the combined materials under step (d) are fermentation is completed within 12 h to 10 months such as within 12 h to 1 month. In a preferred embodiment, the combined materials under step (d) are the fermentation is completed within 24 h to 7 days, such as within 5 days. Preferably the fermentation is terminated before 14 days to ensure high viability of the lactic acid-producing bacteria in the fermented livestock feed obtained by the method.

In a preferred embodiment, the moisture content during the fermentation step (d) is in the range of 27.5% to 50% (preferably 32 to 38%) by weight dry matter (wt %) and the temperature during the fermentation step (d) is in the range of 30 to 40° C. and the fermentation step (d) is completed within 24 h to 7 days, such as within 5 days.

The fermentation step (d) can be performed at different temperature ranges. Commonly, fermentation is performed at a temperature between 5° C. and 55° C. such as between 5° C. and 50° C., or between 15° C. 40° C. In one embodiment, the combined materials under step (d) is fermented at average temperature in the range of 20 to 55° C. such as between 5° C. and 50° C., preferably 35° C. In one embodiment, the fermentation step (d) is conducted at a temperature between 10-50° C., 15-40° C., 18-30° C., 20-25° C., or 22-24° C., at 23° C. or at or around room temperature. However, in the preferred embodiment the temperature during the fermentation is in the range of 30 to 40° C. such as about 35° C. In yet another embodiment of the invention, means for monitoring and controlling temperature are provided. In yet a further embodiment of the invention, the temperature of the water added for providing an appropriate water content of the fermentation broth is essentially controlling fermentation temperature. Fermentation temperature can be constant, or it may vary.

In another embodiment, the pH of the product obtained in step (d) is 4.2 or below, such as in the range of 4.2 and 3.5, in the range of 3.9 and 3.7, or 3.8. In a further embodiment, the pH of the inoculum of step (a) is 4.2 or below, such as in the range of 4.2 and 3.5, in the range of 3.9 and 3.7, or 3.8.

Lactic acid bacteria produce lactic acid during fermentation of a fermentable carbon source, which results in acidification of the environment. Depending on the starter culture or starter cultures used, as well as on the availability of fermentable sugar(s), a fermented feed is obtained by the method according to the invention. In one embodiment, said fermented feed obtained by the fermentation step (d) has a lactic acid concentration above 50 mM. In another embodiment, lactic acid concentration exceeds 100 mM. In a further embodiment, the lactic acid concentration lactic exceeds 150 mM or 200 mM. In yet another embodiment, lactic acid concentrations of above 250 mM or above 300 mM are provided in the fermented product. Thus in one embodiment, the lactic acid concentration in the product obtained in step (d) is in the range of 50-300 mM, 50-100 mM, 100-150 mM, 150-200 mM, 200-250 mM, 250-300 mM, or higher than 300 mM.

The lactic acid concentration in the inoculum for the fermentation according to the invention can be higher than the lactic acid concentration in the fermented feed obtained by the fermentation in step (d). In another embodiment of the invention, the lactic acid concentration in the fermented feed obtained by the fermentation in step (d) is higher than in the inoculum. In a further embodiment, the lactic acid concentrations of inoculum and fermented product are approximately the same.

Likewise, pH of incoculum and fermented product of step (d) can be the same, similar or different. In one embodiment of the invention, the pH of inoculum is below 4.2. In another embodiment, the pH of the inoculum of step (a) is 4.2 or below, such as in the range of 4.2 and 3.5, in the range of 3.9 and 3.7, or 3.8.

According to the invention, the method of preparing a fermented livestock feed can be performed within 1 day, or within 12-24 hours (h). In another embodiment, the fermented product can be produced between 8-12 hours, or 6-8 hours. In a further embodiment, the fermentation is achieved between 4-6 hours, or below 4 hours. Preferably, the preparation of the fermented livestock feed is completed within 24 h to 7 days, such as within 5 days

In another embodiment of the invention, the fermentation in step (d) can be slower, and can take one or more days, several days, one week, several weeks, one month, or several months. Fermentation may be controlled by adding a fermented liquid product or a mixed fermented feed as inoculum comprising active lactic acid bacteria.

The fermentation process can take place in a closed silo. In another embodiment of the invention, fermentation occurs in bales tightly wrapped in plastic wrappers.

In one embodiment of the present invention, the fermentation in step (d) is essentially a homofermentative process. “Essentially homofermentative” means, that the predominant bacterial flora driving the fermentation is homofermentative. In one embodiment, 99% or more of the bacteria are homofermentative. In another embodiment of the invention, 95% or more of the bacteria are homofermentative. In yet another embodiment, 90% or more of the bacteria are homofermentative. In one embodiment, 80% or more of the bacteria are homofermentative In yet another embodiment, 70% or more of the bacteria are homofermentative. “Essentially homofermentative” indicates also that the major fermentation product is lactic acid, and the levels of acetic acid and ethanol are either below taste threshold, around taste threshold or slightly above taste threshold. Alternatively, “essentially homofermentative” indicates a ratio of lactic acid to acetic acid or lactic acid to ethanol (mM/mM) of 7:1 or 10:1 or more, 20:1 or more, 50:1 or more, or 100:1 or more. Where the feed is for use as dried feed, the ratio of lactic acid to acetic acid or lactic acid to ethanol (mM/mM) may be 1:1. According to the invention, both fermentations are essentially homofermentative, i.e. fermentation of the fermented (by-) product as well fermentation of the feed product (barley, wheat, soy etc.). In another embodiment of the invention, the fermentation process is a heterofermentative process. In a further embodiment of the invention, inoculom comprises homo- and heterofermentative lactic acid bacteria. In yet another embodiment of the invention, the inoculom comprises non-lactic acid bacteria.

Thus one embodiment of the invention, the fermented product obtained in step (c) is obtained by essentially a homo-fermentative fermentation and said inoculom comprises lactic acid producing bacteria. Accordingly, in one embodiment the fermentation in step (c) is essentially a homo-fermentative fermentation.

In another embodiment of the invention, the fermented product obtained in step (c) is obtained by hetero-fermentative fermentation. Accordingly, in one embodiment the fermentation in step (c) is essentially a homo-fermentative fermentation. The fermented feed obtained by hetero-fermentative fermentation is preferentially used in the form of dried feed. Thus, when hetero-fermentative fermentation is employed, the fermented feed is preferably dried and used in the dried form.

Feed and Uses Thereof

The present invention further provides fermented livestock feed obtainable/obtained by the method according to any of the preceding claims. The feed obtained by the method of the present invention may be mixed with other feeds such as a feed obtained by the method of the present invention using different starting materials for the fermentation of the proteinaceous feed material (e.g. comprising or consisting of different independently selected proteinaceous plant materials). The feed may for example be mixed after the fermentation has been terminated e.g. before drying the fermented feed or after the feed has been dried.

A second aspect of the present invention provides a fermented livestock feed obtainable/obtained by the method according to any of the preceding claims.

In another embodiment, said feed is provided as a dry feed. In a preferred embodiment, the fermented livestock feed is a silage. In a particular embodiment, the water content of the fermented livestock feed does not exceed 16% by weight. In a preferred embodiment, the concentration of viable lactic acid producing bacteria in said fermented livestock feed is above 10⁷ CFU per gram fermented livestock feed, such as in the 10⁸ to 10⁹ CFU per gram fermented livestock feed. In a more preferred embodiment, the concentration of viable lactic acid producing bacteria in said fermented livestock feed, having a water content of not exceeding 16% by weight, is above 10⁷ CFU per gram fermented livestock feed, such as in the 10⁸ to 10⁹ CFU per gram fermented livestock feed.

A third aspect of the present invention concerns the use of the fermented livestock feed of the present invention for feeding livestock such as a monogastric animals such as pigs or poultry.

It should be noted that embodiments and features described in the context of one of the aspects of the present invention also apply to the other aspects of the invention.

All patent and non-patent references cited in the present application, are hereby incorporated by reference in their entirety.

The invention will now be described in further details in the following non-limiting examples.

### EXAMPLES

Wheat bran having a dry matter content of 15% and a temperature approximately 20° C. is mixed with an inoculum based on potato peels and cooked potatoes (an industrial product also referred to as potato peals) having a dry matter content of 12.5% and supplied with lactic acid bacteria. The temperature of the mixture is approximately 45° C.

Rape meal having a dry matter content of 12%.

Sunflower meal having a dry matter content of 12%. Horse bean meal having a dry matter content of 15%.

### Example 1

60% rape meal,

24% inoculum,

11% wheat bran.

The mixture having a temperature of approximately 35° C. is transferred to a fermenter and fermented for 7 days. The moisture content of the product is subsequently reduced to 12% to obtain a product having a dry matter content of 88%.

### Example 2

30% rape meal,

30% sunflower meal,

24% inoculums,

11% wheat bran.

The mixture having a temperature of approximately 35° C. is transferred to a fermenter and fermented for 7 days. The moisture content of the product is subsequently reduced to 12% to obtain a product having a dry matter content of 88%.

### Example 3

20% rape meal,

20% horse bean,

20% sunflower meal,

24% inoculums,

11% wheat bran.

The mixture having a temperature of approximately 35° C. is transferred to a fermenter and fermented for 7 days. The moisture content of the product is subsequently reduced to 12% to obtain a product having a dry matter content of 88%.

1. A method of preparing a fermented livestock feed, comprising:
(a) providing an inoculum comprising bacteria, wherein said bacteria are lactic acid-producing bacteria and, wherein the concentration of lactic acid-producing bacteria in the inoculum is sufficient to outgrow any bacteria, yeast or mould present in the product of step (b) and (c);
(b) providing a proteinaceous feed material to be fermented, wherein said feed material comprises at least two independently selected proteinaceous plant materials, wherein the protein content of said proteinaceous plant materials is at least 20% by weight;
(c) providing a source of phytase in the form of plant material obtained from a crop selected from the group consisting of wheat, rye, triticale, barley, and spring barley or a combination thereof;
(d) combining the materials of steps (a), (b) and (c); and
(e) fermenting the product of step (b) using the inoculum of step (a) under anaerobic conditions condition.

2-19. (canceled)

20. The method of claim 1, wherein said source of phytase is in the form of a plant material obtained from triticale.

21. The method according to claim 1, wherein steps (d) and (e) are completed within 7-14 days.

22. The method according to claim 1, wherein the product of step (b) is fermented by homofermentive fermentation.

23. The method according to claim 1, wherein the moisture content during the fermentation in step (e) is in the range of 27.5% to 50% by weight dry matter (wt %).

24. The method according to claim 1, wherein temperature during fermentation in step (e) is in the range of 15 to 40° C.

25. The method according to claim 1, wherein steps (d) and (e) are completed within 24 hours and 14 days.

26. The method according to claim 1, wherein said source of phytase is provided in the form of grain or bran.

27. The method according to claim 1, wherein the products of steps (a), (b) and (c) are combined such that the content of said source of phytase in the combination is in the range of 10 to 40% by weight.

28. The method according to claim 1, wherein said feed product of step (b) comprises at least three independently proteinaceous plant materials.

29. The method according to claim 1, wherein said feed material comprises at least one proteinaceous plant material that is a leguminous crop or a leguminous crop-derived material, and wherein said leguminous crop is selected from the group consisting of lupine, Vicia faba, Pisum sativum, and Medicago sativa (Alfalfa) or variants or a combination thereof.

30. The method according to claim 1, wherein said feed material comprises at least one proteinaceous plant material derived from rape, a Brassica rapa ssp. rapa, a Brassica rapa. var. Sylvestris, a sunflower, an algae or a seaweed.

31. The method according to claim 1, wherein the amount of the proteinaceous feed material to be fermented in the combination of the products (a), (b) and (c) is above 15% by weight dry matter (wt %).

32. The method according to claim 1, further comprising drying the product of step (e), wherein the product is dried to a water content not exceeding 16% by weight dry matter.

33. The method according to claim 1, wherein concentration of viable lactic acid producing bacteria in said fermented livestock feed is above 10⁷ CFU per gram fermented livestock feed.

34. A fermented dry livestock feed obtained by the method according to claim 1.

35. The fermented livestock feed according to claim 34, wherein said feed is a dry feed.

36. A method of feeding livestock comprising:
obtaining a fermented livestock feed by the method of claim 1; and
providing said fermented livestock feed to an animal.
